(19) United States
(12) Patent Application Publication
(10) Pub. No.: US 2025/0068840 A1
(43) Pub. Date: Feb. 27, 2025

(54) DATA SEARCHING METHOD FOR DATA DICTIONARY AND DATA CENTER SYSTEM

(71) Applicants: Inventec (Pudong) Technology Corp., Shanghai (CN); Inventec Corporation, Taipei (TW)

(72) Inventors: Wei-Chao Chen, Taipei (TW); Chen-I Huang, Taipei (TW); Yu-Lun Chang, Taipei (TW); Chuo-Jui Wu, Taipei (TW)

(73) Assignees: Inventec (Pudong) Technology Corp., Shanghai (CN); Inventec Corporation, Taipei (TW)

(21) Appl. No.: 18/381,645

(22) Filed: Oct. 19, 2023

(30) Foreign Application Priority Data
Aug. 25, 2023 (CN) 202311087223.1

(51) Int. Cl. G06F 40/247; G06F 40/242; G06F 40/284; G06F 40/30

(52) U.S. Cl. CPC G06F 40/247; G06F 40/242; G06F 40/284; G06F 40/30

(57) ABSTRACT

A data searching method for a data dictionary, comprising obtaining an input word and performing a word embedding operation on the input word to generate a word vector of the input word, calculating a degree of correlation between the input word and a plurality of words in the data dictionary according to the word vector of the input word, and determining at least one recommendation synonym from the plurality of words in the data dictionary according to the degree of correlation between the input word and the plurality of words in the data dictionary, wherein the step including when determining that the cosine similarity between the word vector of the input word and a word vector of a first word of the plurality of words in the data dictionary is greater than a threshold value, determining the first word as a recommendation synonym.

### BACKGROUND OF THE INVENTION

### 1. Field of the Invention

The present invention relates to a data searching method for a data dictionary and a data center system, and more particularly, to a data searching method for a data dictionary and a data center system capable of providing recommendation synonyms.

### 2. Description of the Prior Art

The words in current data dictionary are usually created based on specific rules, and synonyms and related words are all strong links. The user needs to manually input and set the word, and the synonyms and associated words of the word through the data dictionary interface, so that there are strong links between the manually set word and its synonyms and related words. Since there are strong links between the set word and its synonyms and related words, it is easy to have a word mismatch result while querying data dictionary. The word mismatch result means that the word inputted by the user may be different from the words preset in the data dictionary, and thus no query result is outputted while querying data dictionary. In short, the conventional word adding method for data dictionary requires manual setting, thus resulting in a time-consuming and laborious process. Further, because the data dictionary is developed based on specific rules, the user needs to use predefined rules to query words in the data dictionary, so it is difficult to adapt to new or expanding data and lacks adaptability. Moreover, with the increase of the number of rules, the management and maintenance become more complicated and the rule database must be expanded to adapt to the search query with a large amount of data. Thus, there is a need for improvement.

### SUMMARY OF THE INVENTION

It is therefore a primary objective of the present invention to provide a data searching method for a data dictionary and a data center system capable of providing recommendation synonyms, in order to resolve the aforementioned problems.

The present invention discloses a data searching method for a data dictionary, comprising: obtaining an input word and performing a word embedding operation on the input word to generate a word vector of the input word; calculating a degree of correlation between the input word and a plurality of words in the data dictionary according to the word vector of the input word, wherein the step comprising calculating a cosine similarity between the word vector of the input word and each of word vectors of the plurality of words; and determining at least one recommendation synonym from the plurality of words in the data dictionary according to the degree of correlation between the input word and the plurality of words in the data dictionary, wherein the step comprising when determining that the cosine similarity between the word vector of the input word and a word vector of a first word of the plurality of words in the data dictionary is greater than a threshold value, determining the first word as a recommendation synonym.

The present invention further discloses a data center system, comprising: a data dictionary, comprising a plurality of words; and a processing circuit, coupled to the data dictionary, and configured to obtain an input word and perform a word embedding operation on the input word to generate a word vector of the input word; wherein the processing circuit is configured to calculate a degree of correlation between the input word and the plurality of words in the data dictionary according to the word vector of the input word and determine at least one recommendation synonym from the plurality of words in the data dictionary according to the degree of correlation between the input word and the plurality of words in the data dictionary, wherein the processing circuit is configured to calculate a cosine similarity between the word vector of the input word and each of word vectors of the plurality of words, and when determining that the cosine similarity between the word vector of the input word and a word vector of a first word of the plurality of words in the data dictionary is greater than a threshold value, the processing circuit is configured to determine the first word as a recommendation synonym.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a data center system according to an embodiment of the present invention.

FIG. 2 is a flow diagram of a procedure according to an embodiment of the present invention.

FIG. 3 is a schematic diagram of word vectors of input words and words of the data dictionary in a three-dimensional space according to an embodiment of the present invention.

FIG. 4 is a schematic diagram of the recommended synonym according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

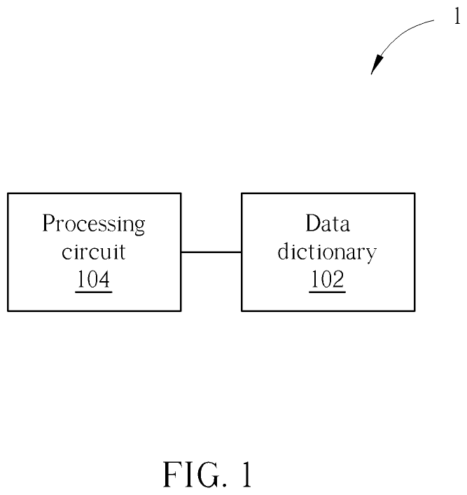

Please refer to FIG. 1, which is a schematic diagram of a data center system 1 according to an embodiment of the present invention. The data center system 1 includes a data dictionary 102 and a processing circuit 104. The data dictionary 102 stores a plurality of words and word vectors of the plurality of words. For each word in the data dictionary 102, the definition, Chinese name and English name of each word may be inputted when building the data dictionary 102. The processing circuit 104 may perform a word embedding operation on the definition, Chinese name and English name of each word to generate a word vector of each word, and store the word vector of each vector into the data dictionary 102 for subsequent use. As such, the user only needs to edit the words through the data dictionary interface without manually setting rules of synonyms and related words. For example, the processing circuit 104 may use a natural language processing model to perform an embedding operation on each word to generate a word vector of each word. For example, the natural processing may language model include a text-embedding-ada-002 embedding model of OPENAI software or a bidirectional encoder representations from transformers (BERT) model, but not limited thereto.

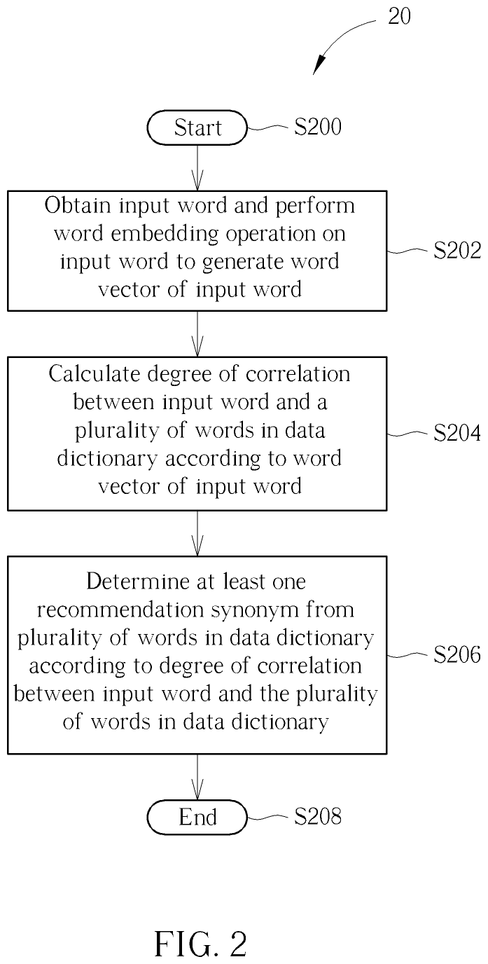

Please refer to FIG. 2. FIG. 2 is a flow diagram of a procedure 20 according to an embodiment of the present invention. The procedure 20 includes the following steps:

Step S200: Start.

Step S202: Obtain an input word and perform a word embedding operation on the input word to generate a word vector of the input word.

Step S204: Calculate a degree of correlation between the input word and a plurality of words in the data dictionary according to the word vector of the input word.

Step S206: Determine at least one recommendation synonym from the plurality of words in the data dictionary according to the degree of correlation between the input word and the plurality of words in the data dictionary

Step S208: End.

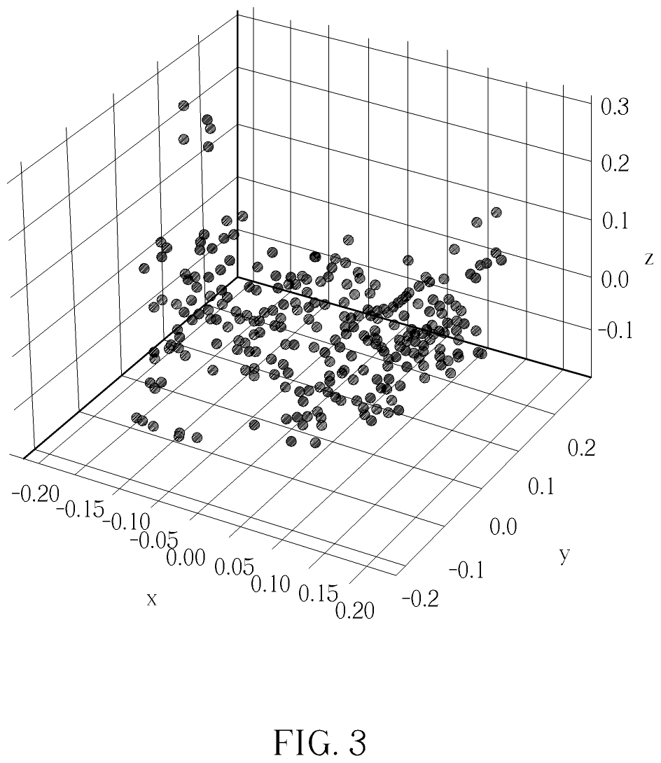

According to the procedure 20, in Step S202, when the user has requirements to search for synonyms, the user may input an input word to the data center system 1. After receiving the input word inputted by the user, the processing circuit 104 may perform a word embedding operation on the input word to generate a word vector of the input word. For example, the processing circuit 104 may utilize a natural language processing model to perform an embedding operation on the input word to generate the word vector of the input word. The processing circuit 104 may store the input word and the word vector of the input word into the data dictionary 102 for subsequent use. As shown in FIG. 3, after the word is converted into a word vector, the word vector may be represented by a dot in the three-dimensional space. That is, each dot represents a word (e.g., an input word or a word in the data dictionary 102). The dots representing words in related fields may be close to each other. The processing circuit 104 calculates the word vectors of the input word and the plurality of words of the data dictionary 102. The word vectors may be distribution distances of the input word and the plurality of words of the data dictionary 102 in space. As a result, weak links between the input word and the plurality of words of the data dictionary 102 may be established through the distribution of the word vectors.

In Step S204, the processing circuit 104 may calculate the degree of correlation between the input word and the plurality of words in the data dictionary 102 according to the word vector of the input word. For example, the processing circuit 104 may calculate a cosine similarity between the word vector of the input word and each of the word vectors of the plurality of words for acting as a correlation between the input word and the word of the data dictionary 102.

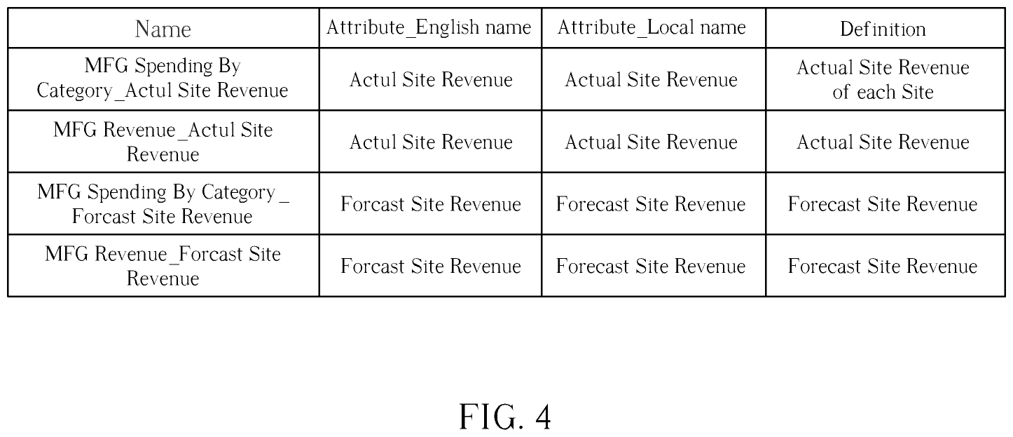

In Step S206, the processing circuit 104 may determine at least one recommendation synonym from the plurality of words in the data dictionary 102 according to the degree of correlation between the input word and the plurality of words in the data dictionary 102. For example, the processing circuit 104 may determine at least one word of the plurality of words in the data dictionary 102 that is highly correlated with the input word according to the degree of correlation between the input word and the plurality of words in the data dictionary 102, and determine the at least one word which is highly correlated with the input word as the at least one recommendation synonym. The processing circuit 104 may output the determined recommendation synonyms for the user. For example, assume that 991 words are collected in the data dictionary 102 during the current data governance process, and the input word inputted by the user in Step S202 is “revenue-related information”. After the processing of Steps S204 and S206, the processing circuit 104 outputs the recommendation synonyms as shown in FIG. 4 for the user.

In step S206, the processing circuit 104 may determine whether the cosine similarity between the word vector of the input word and the word vector of each word in the data dictionary 102 is greater than a threshold. When determining that the cosine similarity between the word vector of the input word and the word vector of one of the plurality of word in the data dictionary 102 is greater than the threshold value, the processing circuit 104 may determine the word of the data dictionary 102 as a recommendation synonym. In other words, the embodiments of the present invention may determine the recommendation synonyms for the user by calculating the degree of correlation through the word vectors of the words, without manually setting synonyms for each word. Therefore, as the company continues to facilitate the development of data governance and the word database may become larger and larger, the method for recommending synonyms of the embodiments of the present invention may significantly improve the efficiency of synonym searching and reduce time required and manpower.

In Step S206, after the recommendation synonyms are determined, the user may check and estimate the determined recommendation synonyms, and accordingly decide whether to further set the recommendation synonyms as synonyms of the input word. As the user decides to set the recommendation synonyms as synonyms of the input word, the synonyms of the input word may be stored into the data dictionary 102. After that, when a search term entered by the user is the same as the input word, the data dictionary 102 may also output the set synonym information of the input word for the user.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system or combination thereof. An example of the means may be the data center system 1. Examples of hardware can include analog, digital and/or mixed circuits known as microcircuit, microchip, or silicon chip. For example, the hardware may include application-specific integrated circuit (ASIC), field programmable gate array (FPGA), programmable logic device, coupled hardware components or combination thereof. In another example, the hardware may include general-purpose processor, microprocessor, controller, digital signal processor (DSP) or combination thereof. Examples of the software may include set(s) of codes, set(s) of instructions and/or set(s) of functions retained (e.g., stored) in a storage device, e.g., a non-transitory computer-readable medium. The non-transitory computer-readable storage medium may include read-only memory (ROM), flash memory, random access memory (RAM), subscriber identity module (SIM), hard disk, floppy diskette, or CD-ROM/DVD-ROM/BD-ROM, but not limited thereto. The data center system 1 of the embodiments of the invention may include the processing circuit 104 and a storage device. Any of the abovementioned procedures and examples above may be compiled into program codes or instructions that are stored in the storage device or a computer-readable medium. The processing circuit 104 may read and execute the program codes or the instructions stored in the storage device storage device or computer-readable medium for realizing the abovementioned functions.

To sum up, the embodiments of the present invention provide a simple and fast method for determining recommendation synonyms for users by calculating the degree of correlation using the word vectors of the words, without manually setting synonyms for each word in the data dictionary. As the company continues to promote data governance, the word database would become larger and larger, and the method for recommending synonyms of the embodiments of the present invention may significantly improve the efficiency of synonym searching and reduce time and manpower.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data searching method for a data dictionary, comprising:
obtaining an input word and performing a word embedding operation on the input word to generate a word vector of the input word;
calculating a degree of correlation between the input word and a plurality of words in the data dictionary according to the word vector of the input word, wherein the step comprising calculating a cosine similarity between the word vector of the input word and each of word vectors of the plurality of words; and
determining at least one recommendation synonym from the plurality of words in the data dictionary according to the degree of correlation between the input word and the plurality of words in the data dictionary, wherein the step comprising when determining that the cosine similarity between the word vector of the input word and a word vector of a first word of the plurality of words in the data dictionary is greater than a threshold value, determining the first word as a recommendation synonym.

2. The data searching method of claim 1, wherein the step of performing the word embedding operation on the input word to generate the word vector of the input word comprises:
utilizing a natural language processing model to perform the word embedding operation on the input word to generate the word vector of the input word.

3. The data searching method of claim 1, further comprising:
utilizing a natural language processing model to perform the word embedding operation on the plurality of words in the data dictionary to generate word vectors of the plurality of words in the data dictionary.

4. The data searching method of claim 1, wherein the step of determining at least one recommendation synonym from the plurality of words in the data dictionary according to the degree of correlation between the input word and the plurality of words in the data dictionary comprises:
determining at least one word of the plurality of words in the data dictionary that is highly correlated with the input word according to the degree of correlation between the input word and the plurality of words in the data dictionary, and determining the at least one word which is highly correlated with the input word as the at least one recommendation synonym.

5. A data center system, comprising:
a data dictionary, comprising a plurality of words; and
a processing circuit, coupled to the data dictionary, and configured to obtain an input word and perform a word embedding operation on the input word to generate a word vector of the input word;
wherein the processing circuit is configured to calculate a degree of correlation between the input word and the plurality of words in the data dictionary according to the word vector of the input word and determine at least one recommendation synonym from the plurality of words in the data dictionary according to the degree of correlation between the input word and the plurality of words in the data dictionary, wherein the processing circuit is configured to calculate a cosine similarity between the word vector of the input word and each of word vectors of the plurality of words, and when determining that the cosine similarity between the word vector of the input word and a word vector of a first word of the plurality of words in the data dictionary is greater than a threshold value, the processing circuit is configured to determine the first word as a recommendation synonym.

6. The data center system of claim 5, wherein the processing circuit is configured to perform the word embedding operation on the input word to generate the word vector of the input word by utilizing a natural language processing model.

7. The data center system of claim 5, wherein the processing circuit is configured to perform the word embedding operation on the plurality of words in the data dictionary to generate word vectors of the plurality of words in the data dictionary by utilizing a natural language processing model.

8. The data center system of claim 5, wherein the processing circuit is configured to determine at least one word of the plurality of words in the data dictionary that is highly correlated with the input word according to the degree of correlation between the input word and the plurality of words in the data dictionary, and determine the at least one word which is highly correlated with the input word as the at least one recommendation synonym.
